(19) United States
(12) Patent Application Publication
(10) Pub. No.: US 2009/0156198 A1
(43) Pub. Date: Jun. 18, 2009

(54) METHOD FOR EVALUATING MOBILE COMMUNICATION DEVICE UTILIZING FIELD TEST LOGS AND SYSTEM THEREOF

(76) Inventor: Ching-Hao Lee, Tao-Yuan City (TW)

Correspondence Address: NORTH AMERICA INTELLECTUAL PROPERTY CORPORATION, P.O. BOX 506, MERRIFIELD, VA, 22116, US

(21) Appl. No.: 11/956,340

(22) Filed: Dec. 14, 2007

(51) Int. Cl. H04Q 7/20

(52) U.S. Cl. 455/425; 455/423

(57) ABSTRACT

A method for evaluating a mobile communication device includes: providing a mobile device having an embedded global navigation satellite system function; performing a field test utilizing the mobile device in a test route being formed by a plurality of locations; generating a test log for the field test, the test log including status data and location messages of the mobile device during the field test; transferring the test log to a log database; displaying the test route on a user interface map by utilizing the location messages for the test route being stored in the log database to thereby indicate corresponding points on the user interface map; and hyper-linking between each point on the user interface map and the location message of the mobile device for the field test being stored in the log database.

### BACKGROUND OF THE INVENTION

1. Field of the Invention

The present invention relates to a method and system for evaluating a mobile communication device, and more particularly, a method for evaluating a mobile communication device utilizing field test logs and geographical map representations and a system thereof.

2. Description of the Prior Art

As mobile devices continue to permeate applications in modern society and as people today rely more heavily upon their mobile communications devices, manufacturers and consumers alike are becoming increasingly concerned with the quality of these devices. As such, manufacturers are placing additional emphasis on real-world test environments for their devices in development as a further step towards minimizing faults and bugs in their products after they are released to market.

These stages of real world test environments and scenarios have manifested into what are known today as “field tests” or “field trials”. In a field test (field trial), a mobile user equipment (UE) labeled as the “equipment under test” (EUT) is tested against many test cases while traveling along a test route, which is formed from one or more geographical locations. Field tests are often conducted by driving the mobile device under test in a vehicle along with any auxiliary or monitoring equipment necessary for capturing test results and logs for test analysis, and as such, field tests are understandably also referred to as “drive tests”. As an example, consider a possible test route formed by winding through the Soho neighborhood streets in New York City, or perhaps one stretching from San Francisco to San Jose along the Interstate Highway 101. Mobile device manufacturers and field trials service providers (who perform field tests on behalf of their client mobile device manufacturers) typically follow several pre-determined test routes in order to provide some basis of comparison between field trial runs and to reproduce certain desired mobile network scenarios that may only be evident in specific locations.

FIG. 1 shows a simplified test route map with two example test routes through a geographic area. This example test area 100 is composed of streets 131 through 139. Winding through the streets 131-139 are two example test routes 110 and 120, each having a respective start point 111 and 121 and a respective end point 112 and 122. In the example depicted in FIG. 1, there is also a geographic location 140 where the equipment under test had encountered an error while driving along both routes 110 and 120 on separate field test runs.

During field test runs, the mobile equipment and/or its accompanying auxiliary equipment captures and stores information regarding messaging traffic, network status information such as base stations connected and their respective signal strengths, as well as mobile status information that is activated during test mode in the mobile equipment. But because field test messages and events occur constantly and rapidly, it is clear that over the course of even a field test run of a few hours, vast amounts of data are logged. Even a relatively simplified route such as test route 120 in FIG. 1 can result in a large log file for later analysis, and one can appreciate that for a single mobile device project consisting of multiple field test routes over many days and numerous test runs for each identical test route will give rise to an overwhelming volume of logged data. Comparing this plurality of enormous field test logs for recurring errors or patterns becomes in itself a daunting chore.

Furthermore, in a real-world deployed mobile network, geographic terrain and buildings or other infrastructures introduce large variances in network signal reception and performance. Therefore, precise geographic information during the field test duration(s) is extremely important: a slight difference in location can result in considerable variance in test results. Prior field tests conducted along predetermined routes record the locations of each test on the equipment under test (EUT) in prose description (that is, in words): examples of recorded locations are “intersection of Broome Street and 6^{th} Avenue, Soho, New York City”, “center of Piccadilly Square, London” and “1600 Amphitheatre Parkway, Mountain View, Calif.”. While useful as a note during the field test, such rough descriptions still allow the slight location differences that lead to large discrepancies in field test results. What's more, prose descriptions are time-consuming during the field test and are difficult to search through for later reference or result analysis.

Prior art addresses the test location issue in tandem with the availability of mobile devices now equipped with global navigation satellite system (GNSS) such as the popular Global Positioning System (GPS). In U.S. Pat. No. 7,062,264 (Ko et al), GPS location messages are embedded into selected field test messages and are sent to the network as over-the-air traffic for further analysis and for subsequently improving the mobile network performance in specific locations. U.S. Pat. No. 7,111,318 (Vitale et al) suggests storing the mobile device measurement history and GPS location message together, so that during a following field test run, this information can instruct the field test operator on which tests to conduct in a specific location. Neither of the mentioned patents, however, speaks to solving the problem of having enormous field test log volumes and helping a mobile device manufacturer or a field trials service provider to extract meaningful evaluations of a mobile communication device based on its performance during the field trials.

### SUMMARY OF THE INVENTION

It is therefore an objective of the present invention to solve the aforementioned problems of enormous field test log volumes, and to provide a method and system for evaluating a mobile communication device.

According to an exemplary embodiment of the present invention, a method for evaluating a mobile communication device includes providing a mobile device having an embedded global navigation satellite system function; performing a field test utilizing the mobile device in a test route being formed by a plurality of locations; generating a test log for the field test, the test log including status data of the mobile device and location messages of the mobile device according to the embedded global navigation satellite system function during the field test; transferring the test log to a log database; displaying the test route on a user interface map by utilizing the location messages for the test route being stored in the log database to thereby indicate corresponding points on the user interface map; and hyper-linking between each point on the user interface map and the location message of the mobile device for the field test being stored in the log database.

According to another exemplary embodiment of the present invention, a system for evaluating a mobile communication device includes a mobile device having an embedded global navigation satellite system function for generating a test log from a field test utilizing the mobile device in a test route being formed by a plurality of locations, the test log including status data of the mobile device and location messages of the mobile device according to the embedded global navigation satellite system function during the field test; a log database for receiving the test log generated from the field test utilizing the mobile device in a test route and for storing the test log; a display for displaying a user interface map and contents of the log database; a plotting tool for displaying the test route on the user interface map by utilizing the location messages for the test route being stored in the log database to thereby indicate corresponding points on the user interface map of the display; and a hyper-link between each point on the user interface map and the location message of the mobile device for the field test being stored in the log database.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified test route map with two example test routes through a geographic area according to the related art.

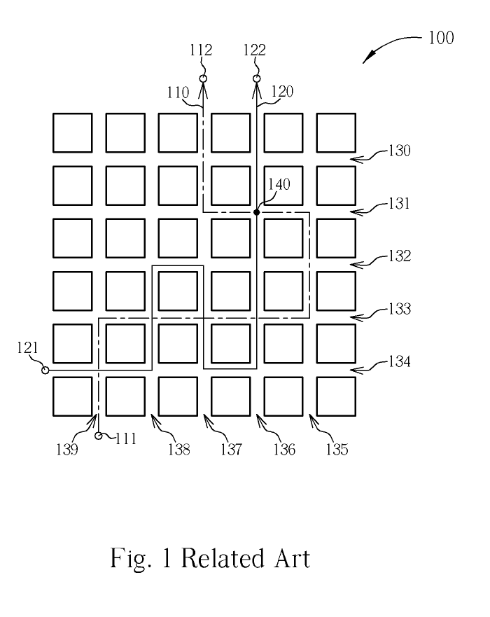

FIG. 2 is block diagram of a field test system according to an exemplary embodiment of the present invention.

FIG. 3 is a flowchart showing a field test method according to an exemplary embodiment of the present invention.

FIG. 4 is an example field test log according to an exemplary embodiment of the present invention.

FIG. 5 is a diagram showing hyper-links between the field test log and the user interface map according to an exemplary embodiment of the present invention.

FIG. 6 illustrates a user scenario according to an exemplary embodiment of the present invention.

FIG. 7 illustrates an evaluation tool comparing whether equipment under test has status error messages only at points on a user interface map being substantially equal to points on the user interface map where a reference device has status error messages according to an exemplary embodiment of the present invention.

### DETAILED DESCRIPTION

The present invention focuses on facilitating the access and management of field test logs with the goal of providing easier and improved evaluation of a mobile device under test.

In the following, the equipment under test (EUT) may be, for example, a mobile handset such as a “Global System for Mobile communications” (GSM) mobile phone or PDA, a device connecting to a third-generation (3G) network such as the Universal Mobile Telecommunications System (UMTS), or may be a device connected via Worldwide Interoperability for Microwave Access (Wi-Max) technology. Additionally, the mobile handset of the described examples will utilize the common Global Positioning System (GPS) function as the embedded global navigation satellite system (GNSS) function. It should be noted that although the examples are specific, the application of the present invention to these networks and technologies is not meant to be a limitation of the scope of this invention. The present invention can be applied to any mobile device which communicates with a network covering a sufficiently wide area and which has embedded in it a location or positioning system with respect to the area. Such applications and embodiments also obey the spirit of and should be considered within the scope of the present invention.

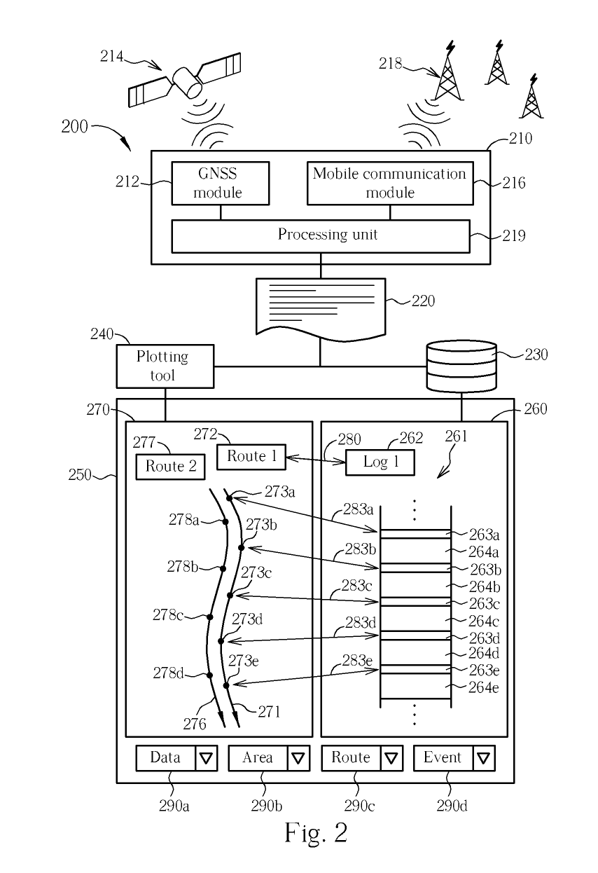

FIG. 2 is a block diagram of a field test system according to an exemplary embodiment of the present invention. The system 200 includes a mobile communication device 210, a global navigation satellite system 214, a mobile network 218, a field test log 220, a log database 230, a plotting tool 240, and a display 250. The mobile device 210 comprises a GNSS module 212 for receiving data from the global navigation satellite system 214, a mobile communication module 216 for communicating with the mobile network 218, and a processing unit 219 for preparing the field test log 220. The field test log 220 is generated by the mobile device 210 and transferred to the log database 230. The log database 230 is for receiving and storing the field test log 220 generated from the field test utilizing the mobile device 210. The plotting tool 240 is coupled to the log database 230, and receives test log data from one of the field test log 220 directly or from the contents of the log database 230. The display 250 is coupled to the log database 230 and the plotting tool 240, and displays log database contents 260 (from the log database 230) as well as a user interface map 270 generated by the plotting tool 240. The contents 260 of the log database 230 contains a test log 261 (derived from the field test log 220) which is identified on the display 250 by a test log label 262, and shows a plurality of location messages 263a-e interlaced with status data messages 264a-e of the mobile device 210. The user interface map 270 displays a field test route 271 identified by its test route label 272, the field test route 271 being marked with the location points 273a-e that comprise the test route 271, which correspond with the location messages 263a-e from the field test log 261. A second route 276 is depicted, shown with a second test route label 277 and having location points 278a-d, but a second field test log is omitted for the sake of simplifying the diagram of FIG. 2. A route hyper-link 280 is connected between the first test log 262 and the first test route 272, and a series of hyper-links connect between the location points 273a-e in the test route 271 of the user interface 270 with their respective location messages 263a-e in the test log 261. Display 250 further includes display criteria 290a-d allows the user to select the test route maps and test logs to be viewed, or even to select the number of test routes viewable. Please note that although the log database 230 above is internal to the system, the log database 230 may instead be external to the mobile device; this is not intended as a limitation on the scope of the present invention.

Please note that although five location messages and five interlaced status messages are presented in this example, it is an arbitrary selection for illustration purposes only and is not intended as a limitation to the present invention. The number of location messages and status messages may vary with the test route, from a single status data and location message to many more. Again, although presented in the example, it is also not a limitation of the present invention to interlace exactly one status data message between each two location messages; a plurality of location messages may be continuously present between two status data messages, and a plurality of status data messages can also exist between two location messages, depending on the test routes.

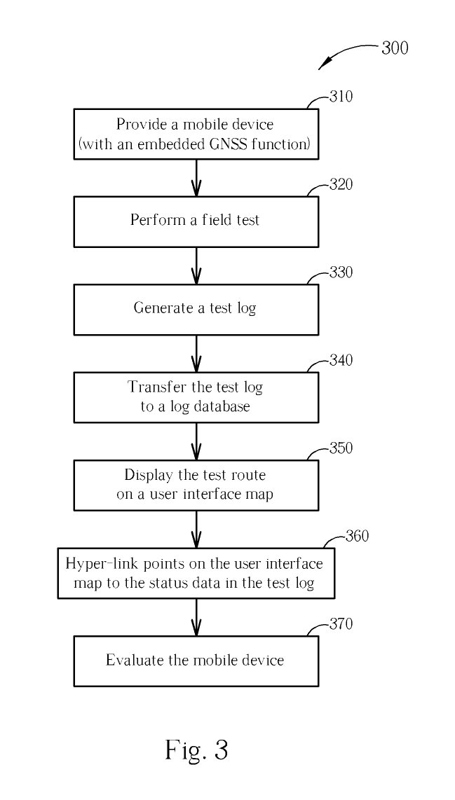

FIG. 3 contains a flowchart showing a field test method of the present invention utilizing the system previously illustrated in FIG. 2. The steps for the method of FIG. 3 are as listed below:

Step 310: Provide a mobile device having an embedded global navigation satellite system function.

Step 320: Perform a field test utilizing the mobile device.

Step 330: Generate a test log for each field test, with status data and location messages during the field test.

Step 340: Transfer the test log to a log database.

Step 350: Display the test route on a user interface map.

Step 360: Hyper-link each point on the user interface map to the location message of the mobile device in the test log.

Step 370: Evaluate the mobile device under test according to the points where the mobile device has status error messages compared to the points where the reference mobile device has status error messages.

The method steps listed above may be performed in any order, and any of the included steps may be integrated, separated, or omitted so as to obtain substantially the same results and goal of the method. Any such manipulation of the steps above (and in FIG. 3) should be considered within the scope and intention of the present invention.

The method according to FIG. 3 begins with Step 310, by providing at least one mobile device 210 having an embedded global navigation satellite system (GNSS) function 212. The mobile devices may be, for example, mobile phones or portable digital assistants (PDAs) utilizing a Global System for Mobile communications (GSM) mobile phone network, a Code-Division Multiple Access (CDMA) network, a Universal Mobile Telecommunications System (UMTS) third-generation (3G) network, or even a Worldwide Interoperability for Microwave Access (Wi-Max) network. The global navigation satellite system (GNSS) function in the examples used is the increasingly popular Global Positioning System (GPS) function. In a specific application of the method of FIG. 3, one of the provided mobile devices 210 is a “reference mobile device”; that is, a mobile device that has previously been certified by a mobile network operator to function correctly and behave as expected on a mobile network 218 operated by the mobile network operator, and is therefore used as a “reference” for other mobile device performance benchmarks. In other applications of the method, the plurality of mobile devices provided in Step 310 are in fact the same device or devices of the same model for testing to achieve additional performance metrics. Step 320 entails performing a sequence of field tests on the provided mobile devices. The field tests are performed along a plurality of test routes formed by a plurality of locations that may be predetermined or may be exploratory. In the case of the reference mobile device, the first field tests on the mobile network 218 using the reference mobile device are presumably already completed, and Step 320 then indicates performing a second field test on the mobile network using the mobile device under test. For each field test and each test route, the mobile device 210 (and any auxiliary or monitoring equipment) will generate a field test log 220 as indicated in Step 330. The field tests together generate a plurality of test logs 220, each test log including status data 264a-e and location messages 263a-e of the mobile device 210 during the field test.

When the field trials are complete and field test logs 220 have been generated, Step 340 involves transferring the field test logs 220 to a log database 230 being external to the mobile devices 210. For a plurality of field test logs 220, an automated workflow is a preferred application to transfer the field test logs 220 into log database 230, but this is neither a requirement nor a limitation for the method of the present invention. From the field test log 220 stored in the log database 230, a plotting tool 240 displays the test routes 271 and 276 on the user interface map 270 of the display 250, as outlined in Step 350. It should be noted that Step 350 may occur immediately after Step 340, or may take place after some time delay, depending on the field trials and work schedule of the encompassing mobile device project. The process of displaying the test route on a user interface map 270 in Step 350 involves utilizing the plotting tool to plot each of the location messages 263a-e in the field test log 261 to corresponding points 273a-e on the user interface map 270 according to the contents (coordinates such as latitude and longitude) of the location messages 263a-e. This step also includes the mapping of the test routes 271 and 276 traveled according to field test log 261, while labeling the test route labels 273 and 277. It should be mentioned that this example (and the diagram of FIG. 2) describes two test routes, but only one test log 261; a second test log corresponding to the plotted test route 276 would exist in the example, but has been omitted for brevity, and for the simplicity of FIG. 2. As an additional component of Step 350, the test routes 271 and 276 are displayed with a line or curve interpolated from the appropriate location messages 263a-e which more clearly indicates the path of the test routes. Please note that the test routes 271 and 276 may not be displayed on the user interface map 270 in their entirety, depending on various criteria set by the display 250 and by the user. For instance, display criteria 290a-d will limit the displayed test routes according to a date or time range, a geographic region, specific test route identifiers, or having at least one point of the test route being of a predetermined status message such as a status error message. By the same token, the user interface map 270 is interactive and can be panned, zoomed, or otherwise manipulated as necessary for viewing purposes.

The succeeding step, Step 360, creates hyper-links 283a-e between each point 273a-e on the user interface map 270 and its respective corresponding location message 263a-e in the field test log 261. As before, substantially the same process is applicable for the test route 276 and the remaining plurality of test routes, but further descriptions are omitted for brevity. The hyper-links 283a-e are preferably bi-directional, meaning a user selects a point (273a, for example) in the user interface map 270 to view the corresponding location message and status data (263a) in the test log 261 of the log database 203, and similarly selects a status message 263a in the test log 261 to view the corresponding point 273a on the user interface map 270; the link works in both directions.

Step 370 of the method shown in the flowchart of FIG. 3 is to evaluate the mobile devices 210 under test, according to the points 273a-e. Where field test logs 261 for more than one mobile device 210 are available, comparisons take place and one example application is comparing points 273a-e on the user interface map 270 corresponding to status data 264a-e and location messages 263a-e of the mobile devices 210 under test to other points on the user interface map 270 corresponding to status data and location messages of a reference mobile device. In a more specific application, the evaluation of Step 370 includes comparing whether the mobile device 210 under test has a status error message only at points on the user interface map being substantially equal to points on the user interface map 270 where the reference mobile device has a status error message, to give a reasonable conclusion that the mobile devices 210 under test are “as good as” the reference mobile device for certain performance parameters.

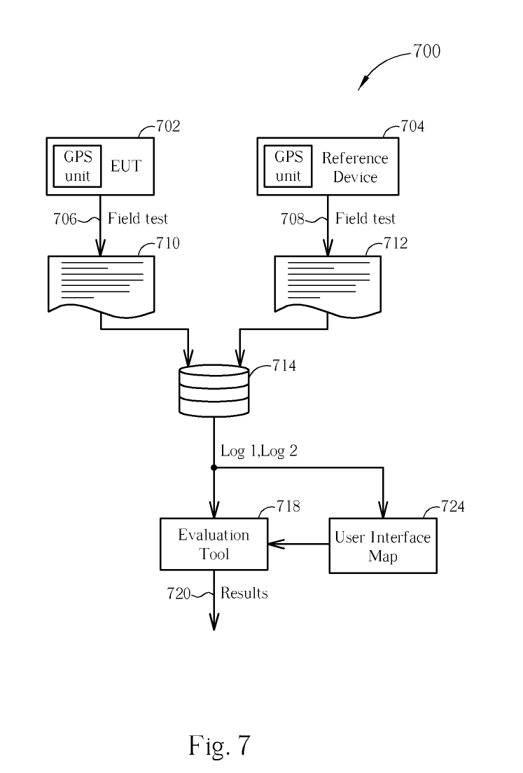

In another embodiment, as shown in FIG. 7, Step 370 can also be automated in the above method by utilizing an evaluation tool 718. In this way, separate field tests 706, 708 can be performed utilizing the equipment under test (EUT) 702 and the reference device 704 to thereby generate first and second logs 710 and 712. These logs 710, 712 are stored in the log database 714, which is coupled to the evaluation tool 718. The evaluation tool 718 then evaluates the EUT 702 according to the points where the EUT 702 has status error messages compared to the points where the reference device 704 has status error messages. Comparison results 720 are generated accordingly. For example, the evaluation tool 718 can compare whether the EUT 702 has status error messages only at points on the user interface map 724 (shown on display 250) being substantially equal to points on the user interface map 724 where the reference device 704 has status error messages. In this case, the EUT 702 is determined to operate correctly with the mobile network when the EUT 702 only has status error messages at points on the user interface map 724 being substantially equal to points on the user interface map 724 where the reference device 704 has status error messages. Should the EUT 702 have status error messages at points being different than where the reference device 704 has status error messages, the evaluation tool 718 outputs results 720 indicating the EUT 702 is not operating correctly with the mobile network.

Returning to the GSM mobile phone example mentioned above, consider a location point 273c of a field test route 271 for mobile device 210 that indicates in the associated test log status data 283c that a dropped call error took place. A comparison and evaluation of Step 370 will involve comparing the dropped call error to other test logs having location points in substantially the same location as location point 273c. If previous test logs show no dropped call errors and perhaps even express better mobile network receiving signal strength indicator (RSSI) values in the same location point as 273c, then an evaluation of the mobile device 210 will include a possible issue with signal reception quality in mobile device 210. Moreover, this comparison and evaluation is applicable for previous test logs from the log database 230 for field tests utilizing the same model device as the mobile device 210 in the same location point 273c.

After reviewing the system, method and examples of the present invention, other applications and implementations will be obvious to those skilled in the art, and thus should be included within the scope of the present invention.

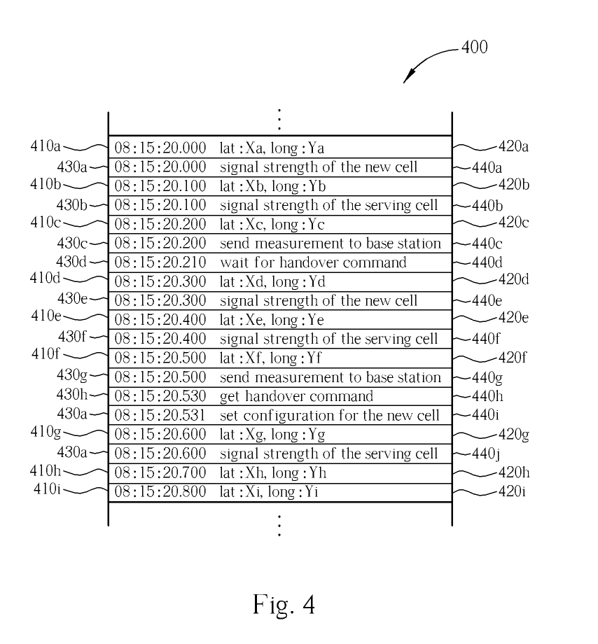

Please recall FIG. 2. With the embedded global navigation satellite system (GNSS) function, the equipment under test (EUT) integrates the device status and traffic messages 264a-e with location positioning messages 263a-e. For a mobile phone field trial example, status data messages 264a-e include timestamps, network communication data, measurement data, and signaling information between the mobile device and a mobile network during the field test, while the location messages 263a-e contain timestamps and location information (such as latitude and longitude). The location messages 263a-e have a predetermined frequency (for example, once per tenth of a second), are triggered to report during status messages, or are a combination of the two occurrences. To illustrate this further, FIG. 4 shows an example portion of a field test log of the present invention. The field test log 400 is composed of location messages 420a-i and status data messages 440a-j, typically recorded in chronological order. The location messages 420a-i each contain a corresponding timestamp 410a-i, and express a location point; in the example given, the GPS location information is expressed as a latitude and longitude pair (Xa, Ya) through (Xi, Yi), corresponding to its respective location message 420a-i. Location message 420c, for instance, has a timestamp 410c of “08:15:20.200” (8:15 am, 20 seconds, and 200 milliseconds) and reports a position of the mobile device 210 as being (Xc, Yc). Similarly, the status data messages 440a-j each contain a corresponding timestamp 430a-j, along with the particular status or event message occurring at that time. For instance, status message 440f with a timestamp 430f of “08:15:20.400” shows a report on the signal strength of the serving mobile network cell. In the example field test log 400 of FIG. 4, each of the location messages 420a-i is separated by 100 milliseconds, providing a constant report on the location of the mobile device 210. As mentioned before, the example of field test log 400 shows it is not necessary for there to be exactly one status data message between each two location messages; a plurality of location messages may be continuously reported between two status data messages, such as location messages 420h and 420i. Likewise, and a plurality of status data messages such as 440g, 440h, and 440i can also exist between two location messages such as 420f and 420g. The order of these messages depends on the activity during the test routes.

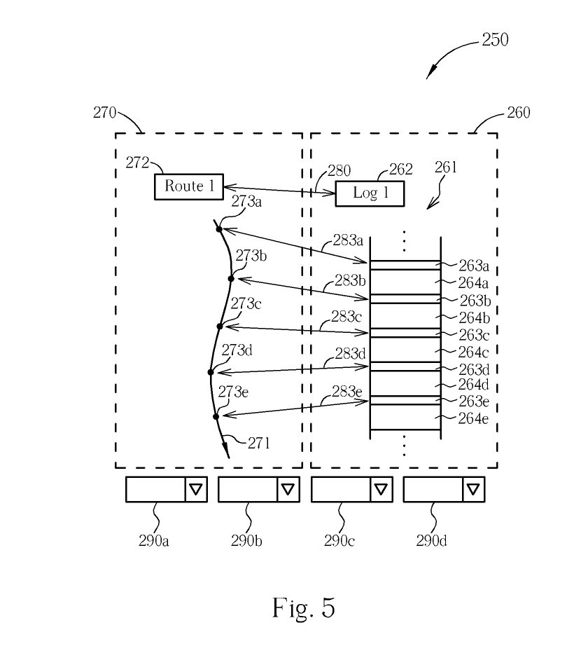

With the field test log 220 in FIG. 2, of which an example is the field test log 400 of FIG. 4, the plotting tool 240 plots the test route onto the user interface map 270 of display 250. FIG. 5 is a simplified diagram extracted from FIG. 2, showing hyper-links between the field test log contents 261 and the user interface map 270 in the present invention. For the purposes of discussing further user scenarios, only the first test route 271 is shown.

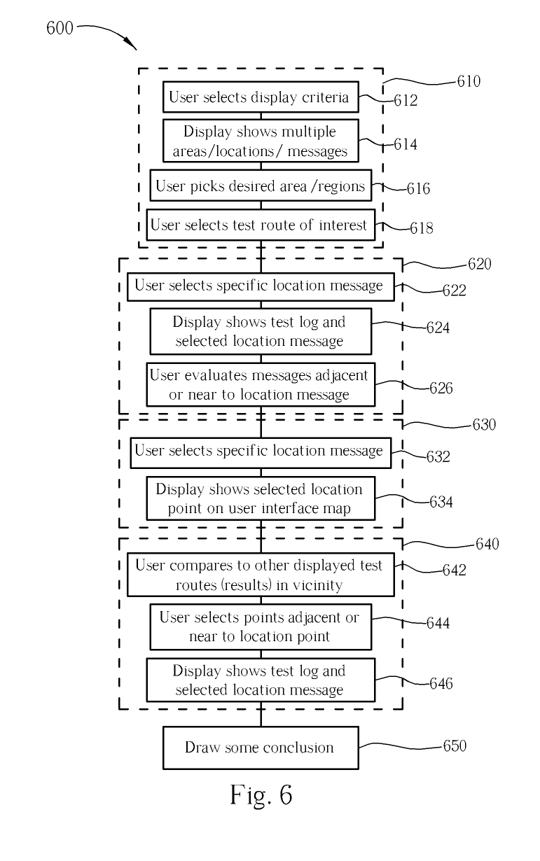

Consider a user scenario where the user is evaluating a mobile device 210 as per the Step 370 of the method in FIG. 3. One user scenario of the present invention, as illustrated by the flowchart 600 in FIG. 6, has a sequence of events as listed below:

Step 610: Find test routes of interest.

Sub-step 612: User selects display criteria.

Sub-step 614: Display shows multiple areas/locations/messages.

Sub-step 616: User picks desired area/regions.

Sub-step 618: User selects test route of interest.

Step 620: Select a map item to view the corresponding log item.

Sub-step 622: User selects specific location message.

Sub-step 624: Display shows test log and selected location message.

Sub-step 626: User evaluates messages adjacent or near to location message.

Step 630: Select a log item to view the corresponding map item.

Sub-step 632: User selects specific location message.

Sub-step 634: Display shows selected location point on user interface map.

Step 640: Compare mobile device results against others.

Sub-step 642: User compares to other displayed test routes (results) in vicinity.

Sub-step 644: User selects points adjacent or near to location point.

Sub-step 646: Display shows test log and selected location message.

Step 650: Evaluate mobile device.

The flowchart 600 consists of 5 steps: finding test routes in Step 610, selecting an item in the user interface map 270 to view the corresponding item in the field test log 261 in Step 620, selecting an item in the field test log 261 to view the corresponding item in the map 270 for Step 630, comparing the results for the mobile device 210 against those of other field tests or field test routes in Step 640, and Step 650 for evaluating the mobile device 210 in question. As described below, each step reveals further information to aid the user (or an automated intelligence) in evaluating the mobile device 210 under test.

In Step 610, the user first finds test routes of interest; this is accomplished via sub-steps 612-618. The user selects in Sub-step 612 the desired criteria 290a-d for test routes to be displayed. As an example, these criteria can be a date/time range (in May and June of 2007), a geographic region or city (San Francisco Bay Area), a test route identifier (or several of them), and specific status messages (dropped call events). The display of the system 200 displays in Sub-step 614 the test routes that match the criteria set in Sub-step 612, which can be one test route or several. Of these returned matching test routes, the user may select a smaller subset as indicated in Sub-step 616 before selecting a particular test route of interest in Sub-step 618.

Step 620 encompasses the shift of the display 250 from displaying the user interface map 270 to displaying the field test log 261. In Sub-step 622, the user selects a specific location message shown on the test route of interest (which was selected in Sub-step 618). In the on-going example, the location point 273b of the field test route 271 corresponds to a dropped call event (a case where a cellular handover failed), or corresponds to an area where the user had a dropped call during the field test. The display 250 shows in Sub-step 624 the corresponding field test log 261 and selected location message 263b, allowing the user to evaluate the status messages 264a-e adjacent or near to location message 263b in Sub-step 626, where the user sees the reason for the handover failure was that the receiving power from the exemplary mobile network cell was too low. Step 630 encompasses the shift of the display 250 from displaying the field test log 261 to displaying the user interface map 270; essentially, it is substantially the opposite shift from Step 620 above. From the field test log 261, in Sub-step 632 the user selects a specific location message 263d, and Sub-step 634 displays the corresponding location point 273d on user interface map 270. Continuing the example, the user finds the dropped call status message 264d and this status message is closest to location message 263d in the field test log 261, whereby the user selects location message 263d and the display 250 shows the corresponding location point 273d on the user interface map 270.

The user compares the results of the current mobile device 210 against other field test results in Step 640, which comprises Sub-steps 642, 644, and 646. In Sub-step 642, the user compares the dropped call status message 264d (found in Sub-step 632) to status messages found in other displayed test routes (not shown or numbered) which have location messages in the vicinity of the related location message 263d. To investigate further, the user in Sub-step 644 selects points adjacent or near to location point 263d and the display 250 in Sub-step 646 shows those corresponding field test logs and associated location messages. From the comparison and references to other field test logs, one of which is a reference mobile device that has previously been certified by the mobile network operator on the same mobile network, the user is able to see that the reference mobile device also exhibits handover failure issues in the same field test location 273d.

Step 650 involves the user having investigated the results of the current mobile device 210 and other results to evaluate the mobile device 210 based on these findings. From the findings in the example, it is clear that the reference mobile device and the mobile device 210 under test exhibit similar or substantially the same issues in substantially the same field test location, and the user asserts the anomaly as an issue with the mobile network and not the mobile device 210 under test.

Though each of Steps 610, 620, 630, 640, and 650 is done in the sequence illustrated in FIG. 6, it is also possible to omit some steps, introduce intervening steps, rearrange the order of these and any new steps, and some combination of the mentioned manipulations in order to achieve substantially the same desired result of evaluating the mobile device. For instance, when the display 250 shows also various status messages directly on the user interface map 270, certain of the steps in the flowchart of FIG. 6 can be omitted without affecting the results or deteriorating the user experience. In another example, when a first search for display criteria produces too many test routes displayed, the user selects tighter criteria to display again.

It should also be noted that some different implementations of the system are possible, including but not limited to the removal or integration of different components to achieve substantially the same result and utility. For example, the GNSS module 212 and mobile communications module 216 are shown in FIG. 2 to produce a single field test log 220 via the processing unit 219, but it is also possible that the GNSS module 212 and mobile communications module 216 each directly record messages to a single field test log 220 without the need for an explicit processing unit 219. The log database 230 can be a structured database, an access-controlled shared directory, a file folder structure, or some other implementation. Numerous modifications to the display and interface are possible, including placement and omission of certain controls or labels (such as test route labels 272 and 277) or route hyper-link 280. For example, the second test route 276 and its associated test route label 277 and its location points 278a-d can be omitted entirely if desired, and this is controlled by the display criteria 290a-d. The test route label 272 may also itself be a hyper-link to, for example, the raw field test log 220. These variations should be considered possible embodiments within the scope of the present invention, and still obey the spirit of the present invention.

Additionally, from the flowchart of FIG. 2, and after reviewing the system, method illustrated above, and the present user scenario of the present invention, other applications and implementations will be obvious to those skilled in the art, and should be included within the scope of the present invention. It is, for example, obvious that the present invention also applies to the field test evaluation for a single mobile device as well as to multiple mobile devices; a plurality of mobile devices, or the field test logs of them, is not strictly required to extract meaningful use from the present invention. While the use of a reference mobile device as one of the multiple devices in the relevant field trial logs is clearly useful, this too is not a strict requirement for the evaluation of a mobile device through the system and method of the present invention. Since the implementation of the present invention lends itself easily to different applications as mentioned above, further description is omitted.

One advantage of the method and system for evaluating a mobile unit communication device according to the present invention is that a location where one or more dropped calls has occurred can be easily located and decided whether or not said dropped call can be disregarded as an anomaly in the mobile network performance. Fast and easy access is allowed to field test logs from the log database in specific locations and the log can be accessed simply via a graphical user interface (GUI) on the map. According to the present invention, it is not necessarily to manually search through large volumes of logs by reading prose location descriptions of the field test log one by one. Instead, logs selection is first made directly on the map and a route-hyperlink is utilized to access a desired log test route. After selecting a field test log by the route-hyperlink, hierarchical access of the field test messages around a specific location by the location-hyperlink between a GPS dot on the map and relative GPS message of the log file is fast and convenient according to the present invention. In contrast to the related art, users of the present invention can also show the test route and locations of a field test log on the map and these geographical messages facility the field test debugging.

Those skilled in the art will readily observe that numerous modifications and alterations of the device and method may be made while retaining the teachings of the invention.

What is claimed is:

1. A method for evaluating a mobile communication device, the method comprising:
providing a mobile device having an embedded global navigation satellite system function;
performing a field test utilizing the mobile device in a test route being formed by a plurality of locations;
generating a test log for the field test, the test log including status data of the mobile device and location messages of the mobile device according to the embedded global navigation satellite system function during the field test;
transferring the test log to a log database;
displaying the test route on a user interface map by utilizing the location messages for the test route being stored in the log database to thereby indicate corresponding points on the user interface map; and
hyper-linking between each point on the user interface map and the location message of the mobile device for the field test being stored in the log database.

2. The method of claim 1, wherein the mobile device is a digital mobile device utilizing a mobile network selected from one of Global System for Mobile communications (GSM), Code-Division Multiple Access (CDMA), Universal Mobile Telecommunications System (UMTS), and Worldwide Interoperability for Microwave Access (Wi-Max).

3. The method of claim 1, wherein the status data of the mobile device includes at least one of timestamps, communication data, measurement data, and signaling information between the mobile device and a mobile network during the field test.

4. The method of claim 1, wherein the location messages of the mobile device include timestamps or location information.

5. The method of claim 1, wherein the method further comprises hyper-linking bi-directionally between each of the points on the user interface map and corresponding location message of the mobile device for the field test being stored in the log database, wherein a user selects a point in the user interface map to view the corresponding location message in the log database and selects a location message to view the corresponding point on the user interface map.

6. The method claimed in claim 1, further comprising:
providing a plurality of mobile devices each having an embedded global navigation satellite system function;
performing a plurality of field tests utilizing the mobile devices in a plurality of test routes;
generating a plurality of test logs, each test log including status data and location messages of one of the mobile devices;
transferring the test logs to the log database;
displaying the test routes on the user interface map by utilizing the location messages for the test routes being stored in the log database to thereby indicate the corresponding points on the user interface map; and
hyper-linking between each of the corresponding points on the user interface map and the corresponding location message of the mobile devices for the field tests being stored in the log database.

7. The method of claim 6, further comprising displaying the test routes from the log database on the user interface map and selecting status messages from the log database according to display criteria.

8. The method of claim 7, wherein the display criteria includes at least one element selected from the group consisting of: a date or time range, a geographic region, a test route identifier, and test routes having at least one point on the user interface map being of a predetermined status message.

9. The method of claim 8, wherein the predetermined status message is a status error message.

10. The method claimed in claim 6, further comprising:
providing a reference mobile device being previously certified by a mobile network operator to function correctly on a mobile network operated by the mobile network operator; and
comparing points on the user interface map corresponding to status data and location messages of a mobile device under test to points on the user interface map corresponding to status data and location messages of the reference mobile device;
wherein performing a plurality of field tests utilizing the mobile devices further includes performing a first field test on the mobile network using the reference mobile device, and performing a second field test on the mobile network using the mobile device under test.

11. The method of claim 10, further comprising:
comparing whether the mobile device under test has a status error message only at points on the user interface map being substantially equal to points on the user interface map where the reference mobile device has a status error message;
wherein the mobile device under test is determined to operate correctly with the mobile network when the mobile device under test only has a status error message at the points on the user interface map being substantially equal to points on the user interface map where the reference mobile device has a status error message.

12. The method of claim 1, wherein the log database is external to the mobile device.

13. A system for evaluating a mobile communication device, the system comprising:
a mobile device having an embedded global navigation satellite system function for generating a test log from a field test utilizing the mobile device in a test route being formed by a plurality of locations, the test log including status data of the mobile device and location messages of the mobile device according to the embedded global navigation satellite system function during the field test;
a log database for receiving the test log generated from the field test utilizing the mobile device in a test route and for storing the test log;
a display for displaying a user interface map and contents of the log database;
a plotting tool for displaying the test route on the user interface map by utilizing the location messages for the test route being stored in the log database to thereby indicate corresponding points on the user interface map of the display; and
a hyper-link between each point on the user interface map and the location message of the mobile device for the field test being stored in the log database.

14. The system of claim 13, wherein the mobile device is a digital mobile device utilizing a mobile network selected from one of Global System for Mobile communications (GSM), Code-Division Multiple Access (CDMA), Universal Mobile Telecommunications System (UMTS), and Worldwide Interoperability for Microwave Access (Wi-Max).

15. The system of claim 13, wherein the status data of the mobile device includes timestamps, communication data, measurement data, and signaling information between the mobile device and a mobile network during the field test.

16. The system of claim 13, wherein the location messages of the mobile device include timestamps or location information.

17. The system of claim 13, wherein each hyper-link is a bi-directional hyper-link between the points on the user interface map and corresponding location message of the mobile device for the field test being stored in the log database, wherein a user selects a point in the user interface map to view the corresponding location message in the log database and selects a location message to view the corresponding point on the user interface map.

18. The system claimed in claim 13, further comprising:
a plurality of mobile devices each having an embedded global navigation satellite system function for generating a plurality of test logs, each test log including status data and location messages of one of the mobile devices; and
a plurality of hyper-links between the corresponding points on the user interface map and the location message of the mobile devices for the field tests being stored in the log database;
wherein the log database is further for receiving and storing the test logs from the plurality of mobile devices after the field tests; and
the plotting tool is further for displaying the test routes on the user interface map by utilizing the location messages for the test routes being stored in the log database to thereby indicate corresponding points on the user interface map of the display.

19. The system of claim 18, wherein the display is further for displaying the test routes from the log database on the user interface map and for selecting status messages from the log database according to display criteria.

20. The system of claim 19, wherein the display criteria includes at least one element selected from the group consisting of: a date or time range, a geographic region, a test route identifier, and test routes having at least one point on the user interface map being of a predetermined status message.

21. The system of claim 20, wherein the predetermined status message is a status error message.

22. The system claimed in claim 18, further comprising:
a reference mobile device being previously certified by a mobile network operator to function correctly on a mobile network operated by the mobile network operator; and
an evaluation tool for comparing points on the user interface map corresponding to status data and location messages of a mobile device under test to points on the user interface map corresponding to status data and location messages of the reference mobile device;
wherein a plurality of field tests utilizing the mobile devices further includes performing a first field test on the mobile network using the reference mobile device, and performing a second field test on the mobile network using the mobile device under test.

23. The system of claim 22, wherein the evaluation tool is further for comparing whether the mobile device under test has a status error message only at points on the user interface map being substantially equal to points on the user interface map where the reference mobile device has a status error message; and the mobile device under test is determined to operate correctly with the mobile network when the mobile device under test only has a status error message at the points on the user interface map being substantially equal to points on the user interface map where the reference mobile device has a status error message.

24. The system of claim 13, wherein the log database is external to the mobile device.
